(19) United States
(12) Patent Application Publication
(10) Pub. No.: US 2025/0340075 A1
(43) Pub. Date: Nov. 6, 2025

(54) A PRINTING APPARATUS

(71) Applicant: Dover Europe Sàrl, Vernier (CH)

(72) Inventor: Biser Ivanov, Nottingham (GB)

(21) Appl. No.: 19/128,157

(22) PCT Filed: Nov. 8, 2023
(86) PCT No.: PCT/EP2023/081211

§ 371 Date: May 7, 2025

(30) Foreign Application Priority Data
Nov. 8, 2022 (GB) 2216624.3

(51) Int. Cl. B41J 25/304; B41J 2/325

(52) U.S. Cl. CPC B41J 25/304; B41J 2/325

(57) ABSTRACT

A printing apparatus for thermal transfer printing, including a controller (10), an actuator (12), and a print head (14) which is moveable by the actuator, between a non-printing position and a printing position, the controller (10) is operable to control movement of the print head (14) from the non-printing position to the printing position by: accelerating the print head (14) towards the printing position, slowing the print head (14) before it reaches the printing position, so that the print head (14) reaches the printing position while being slowed, contacting a surface (16) with the print head in the printing position and increasing a pressure of the print head on the surface to a printing pressure.

### FIELD

The present invention relates to improvements to a printing apparatus and methods of controlling a printing apparatus. In particular, the invention can be applied to thermal transfer over-printers (TTO).

### BACKGROUND

In the field of thermal transfer printing, a reel of inked ribbon (also called [symbol] tape [symbol] ) is typically mounted onto a spool support. The spool support is rotatable to transfer tape from the first (supply) spool to a second (take up) spool into which tape may be wound after/during use. The second spool support is also rotatable. Various methods of operation of such a reel to reel tape drive are known in the art. Tape is typically transferrable between the pair of spools in both directions, but generally speaking, as ink is removed from the tape during successive printing operations, the used tape is wound onto the second [symbol] takeup [symbol] spool, such that the diameter of the supply spool decreases and the diameter of the take-up spool increases.

A print head is provided which includes multiple heating elements. As the inked ribbon is moved through the printing apparatus (between the spool supports), it is passed under the print head (and the heating elements). The inked ribbon is sandwiched between the print head and a substrate on which an image is to be printed. One or more heating elements are heated to melt a portion of ink on the ribbon and it is transferred to the substrate to print.

Typically, a pneumatic actuator has been used to move the print head between its deployed printing position, and its retracted position.

Apart from the infrastructure requirement to deliver compressed air, various studies have shown that efficiency of compressed air systems is in the range of 10% to 15%. Consequently, compressed air actuators are deemed to be more expensive to run in comparison with electrical ones. While there is a high demand for cost-effective actuators, the compressed air solution restricts the TTO market to those factories having compressed air facilities.

Embodiments relating to the present disclosure seek to alleviate one or more of the problems associated with known systems.

### BRIEF DESCRIPTION OF THE INVENTION

According to a first aspect of the invention we provide a printing apparatus for thermal transfer printing, including a controller, an actuator, and a print head which is moveable by the actuator, between a non-printing position and a printing position, the controller is operable to control movement of the print head from the non-printing position to the printing position by:
accelerating the print head towards the printing position,
slowing the print head before it reaches the printing position, so that the print head reaches the printing position while being slowed,
contacting a surface with the print head in the printing position and increasing a pressure of the print head on the surface to a printing pressure.

The controller may apply an acceleration signal to the actuator to accelerate the print head. The acceleration signal may be at or approaching a maximum energy available. The acceleration signal may be at least 90% of the maximum allowable. The acceleration signal may include a first signal to the actuator in a first direction. The controller may apply the acceleration signal for a predetermined acceleration time.

Slowing the print head may include actively decelerating the print head. The controller may apply a braking signal to the actuator to slow the print head. Optionally, the braking signal may include a second signal to the actuator in a second direction. The controller may apply the braking signal for a predetermined braking time. The controller may apply the braking signal in pulses across the predetermined braking time.

The controller may adjust a magnitude of the energy applied during the braking signal according to at least one of:
a mass of the print head,
a width of the print head,
a type and configuration of the actuator,
a supply voltage or power to the actuator,
a temperature of the actuator or environment,
a printing apparatus orientation,
a distance between the non-printing position and the printing position.

As the print head contacts the surface or after the print head contacts the surface, the controller may apply an increasing signal to the actuator. The increasing signal may be at a predetermined rate to reach the printing pressure. The predetermined rate increase may be linear.

The controller may be operable to control movement of the print head from the printing position to the non-printing position by:
accelerating the print head towards the non-printing position, and
slowing the print head before it reaches the non-printing position.

The controller may apply a retraction signal to the actuator to accelerate the print head towards the non-printing position. The retraction signal may be at or approaching a maximum energy available. The retraction signal may include a signal in the second direction to accelerate the print head towards the non-printing position. The controller may apply the retraction signal to the actuator for a predetermined retraction time.

The controller may apply a retraction braking signal to slow the print head before it reaches the non-printing position. Optionally the retraction braking signal may include a signal in the first direction. The controller may apply the retraction braking signal for a predetermined time.

According to a second aspect of the invention we provide a method of operating a printing apparatus in which the controller performs one or more of the features outlined with respect to the first aspect.

According to a third aspect of the invention we provide a printing apparatus for thermal transfer printing, including a controller, an actuator, and a print head which is moveable by the actuator, between a non-printing position and a printing position, the controller is operable to perform a calibration process including:
completing a first cycle including moving the print head from the non-printing position to the printing position, and receiving a signal/data relating to a back-electromotive force formed in/by the actuator,
completing a second cycle including altering one or more parameter(s) relating to the movement of the print head in the first cycle, moving the print head from the non-printing position to the printing position with the updated parameter(s), receiving a signal/data relating to the back-electromotive force formed in/by the actuator, and
comparing the back-electromotive force between the first and second cycles to assess which parameter(s) result in acceptable movement of the print head.

Moving the print head between the non-printing position and the printing position may include the controller:
accelerating the print head towards the printing position by applying an actuation signal to the actuator in a first direction,
slowing the print head before it reaches the printing position, so that the print head reaches the printing position while being slowed.

Slowing the print head may include either removing the actuation signal of the first direction being applied to the actuator. Slowing the print head may include applying a signal in the opposite direction/a second direction to the actuator.

The one or more parameters may include one or more of:
a total energy applied to the actuator to generate the acceleration,
a total energy applied to the actuator to generate slowing or deceleration of the print head, and
a time period over which one or both of above are applied.

The total energy applied to the actuator to generate slowing or deceleration may be influenced by one or more of the following:
a mass of the print head,
a width of the print head,
a type and configuration of the actuator,
a supply voltage or power to the actuator,
a temperature of the actuator or environment,
a printing apparatus orientation,
a distance between the non-printing position and the printing position.

### BRIEF DESCRIPTION OF THE FIGURES

In order that the present disclosure may be more readily understood, preferable embodiments thereof will now be described, by way of example only, with reference to the accompanying drawings, in which:

FIG. 1 illustrates a solenoid configuration alongside associated PWM and current traces, according to embodiments of the disclosure

FIG. 2 illustrate a PWM channel controlling a solenoid, according to embodiments of the disclosure;

FIG. 3 provides example load cell traces according to embodiments of the disclosure;

FIG. 4 provides example PWM scope traces, according to embodiments of the disclosure;

FIG. 5 provides test measurements illustrating the analysis on the Back-EMF after LowPass-Filtering, in accordance with an algorithm to control print head bounce; and

FIG. 6 provides a partial illustration of components of the printing apparatus, according to embodiments of the disclosure.

### DETAILED DESCRIPTION OF THE DISCLOSURE

We provide methods of controlling a printer as described herein, and a printing apparatus configured to operate in accordance with one or more aspects of the methods described. Various mechanisms and techniques for replacing the compressed air solution are described below.

### Print Head Accelerated Drive Overview

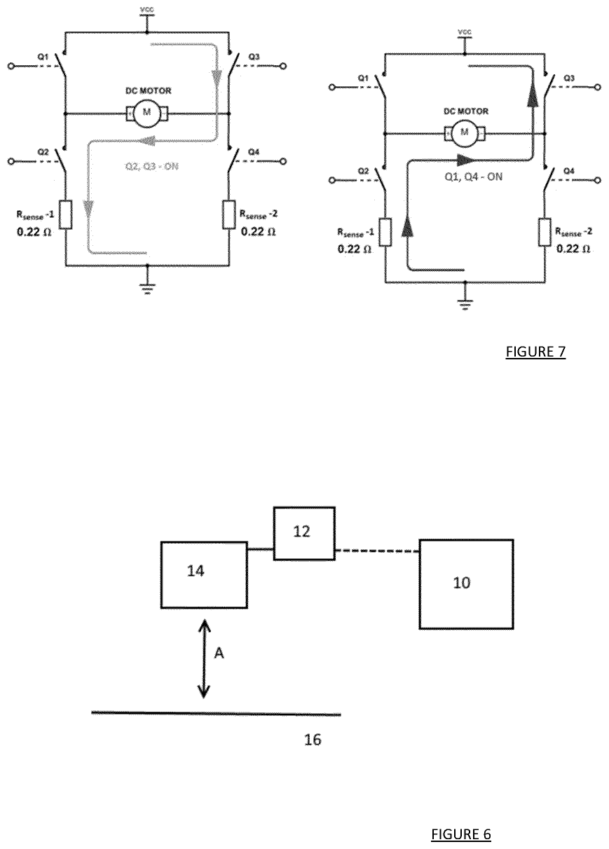

Referring particularly to FIG. 6, part of a printing apparatus for thermal transfer printing is illustrated. The printing apparatus includes a controller 10, a print head actuator 12 (also [symbol] actuator 12), and a print head 14. The print head actuator 12 is an electronically controlled device such as a rotary solenoid or a DC motor [symbol] both are powered by the application of a voltage, which causes generation of mechanical energy. Using a rotary solenoid or DC-motor that has bi-directional control allows the creation of an algorithm that moves the print head 14 towards a print surface 16 as quickly as possible, but with low impact on the targeted surface and controlled momentum.

Print head electrical actuators 12 (such as solenoids and motors) are driven in a controlled manner to ensure the print head 14 reaches the printing position as quickly as possible but does not crash into the print surface 16 (i.e. in a manner that does not cause bouncing due to platen compliance). To get the actuator 12 (the solenoid or DC-motor) moving from a stationary point, the device is given a kick start. This kick start is created by applying the maximum allowable voltage to the solenoid or DC-motor to rapidly increase the magnetic field and accelerate the device [symbol] s moving parts such as plunger, shaft or arm at the fastest rate possible.

The voltage is then dropped and/or reversed in a controlled manner ensuring that the print head 14 reaches its print surface 16 without hitting it hard.

### Algorithm to Control the Print Head Bounce

A traditional pneumatic actuator solution has no control over the speed of the print head 14 when it reaches the print surface 16, so it will bounce for tens of milliseconds. The bouncing delays the printing of an image as the print head 14 pressure needs to be constant to deliver consistent print quality, so the delay creates a slower pack rate (number of prints per minute) but also the hammering impact could have a detrimental effect on the life of the mechanics.

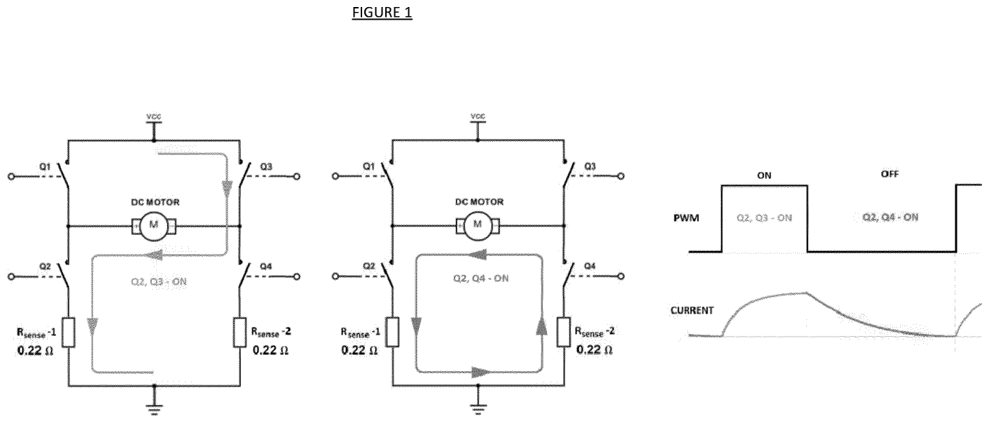

FIG. 1 illustrates an example circuit for applying a potential difference across the actuator 12 (two different scenarios are illustrated on the left and middle). The illustration on the right provides an indication of what the voltage/PWM may look like and the resulting current that may flow in the circuit.

The left circuit illustrates applying a voltage across the actuator 12 (in this example, a DC motor) in a first direction [symbol] the arrowed loop illustrates the direction through the circuit. This results in the increases in the PWM and current illustrated on the right (referenced [symbol] Q2, Q3 [symbol] ON [symbol] in green).

The middle circuit illustrates removing the potential difference across the actuator 12 and allowing the current to dissipate [symbol] the red arrowed loop illustrates the direction through the circuit. In other words, the current is permitted to freewheel. This results in the decreases in the PWM and current illustrated on the right (referenced [symbol] Q2, Q4 [symbol] OFF [symbol] in red).

FIG. 7 also illustrates the same example circuit [symbol] the illustration on the left is the same as the left side of FIG. 1 and the figure on the right illustrates applying a voltage across the actuator 12 in a second direction [symbol] the arrowed loop provides an indication of the direction through the circuit.

It should be appreciated that the circuit may include one or more sense resistors (see Rₛₑₙₛₑ⁻¹ and Rₛₑₙₛₑ⁻²), that are included in the current path to provide means to measure the current (and, thus, calculate the voltage).

The print head 14 is moveable between a non-printing position and a printing position [symbol] the print head actuator 12 drives movement of the print head 12 (controlled by the controller 10) [symbol] see double headed arrow [symbol] A [symbol] in FIG. 6.

The controller 10 is operable to control movement of the print head 14 from the nonprinting position to the printing position by: accelerating the print head 14 towards the printing position, slowing the print head 14 before it reaches the printing position, so that the print head 14 reaches the printing position while being slowed, and contacting the surface 16 (also known as the print surface) with the print head 14 in the printing position and increasing a pressure of the print head 14 on the surface 16 to a printing pressure.

In order to move the print head 14 from the non-printing position to the printing position the controller 10 is operable to control the movement in the following manner. Initially, the print head 14 is accelerated towards the printing position. In this example, the controller 10 applies an acceleration signal to the actuator. In some embodiments, the acceleration signal is at or approaching a maximum energy available. In other words, the total energy applied during the acceleration signal is close to or at the maximum that could possibly be accommodated by the circuitry/hardware components (for example, above 90% of the maximum possible, and more preferably above 95%).

In other words, the acceleration signal includes a first signal to the actuator 12 in a first direction. The acceleration signal is applied for a predetermined acceleration time.

In some embodiments, the controller uses signals in a pulse width modulation (PWM) form. In such an embodiment, a [symbol] high [symbol] signal (i.e. so called maximum energy or high voltage) is built from a consistent voltage applied in pulses of varying lengths. Thus, a maximum energy signal could be built from that consistent voltage being applied for a maximum possible pulse length (and possibly consistently across the entire signal period). A lower energy signal could be built from the same consistent voltage which is applied for a shorter amount of time or across multiple pulses. This is discussed further below.

In some embodiments, the controller 10 accelerates the print head 14 by applying a first voltage to the actuator 12 in a first polarity (i.e. the first direction). In other words, to get the solenoid or motor (and, thus, the print head 14) moving from a stationary point, the actuator 12 is given a kick start i.e. 100% PWM (maximum allowable voltage) for given time. This will rapidly increase the current and the magnetic field and accelerate the device [symbol] s arm at the fastest rate possible [symbol] thus, resulting in acceleration of the print head 14 at its fastest rate possible.

It should be appreciated that the printing apparatus is often oriented so that the print head 14 moves downwards towards a substrate/printing surface 16 and moves upwards to move away from the substrate/printing surface 16. However, this is not necessarily the case and the printing apparatus may be oriented in a different way (e.g. upside down or at an angle) and, as such, the print head 14 may not move downwards in this initial acceleration process. Nevertheless, the print head 14 will be accelerated towards the printing position (and the substrate/printing surface 16).

In embodiments, the controller 10 applies a high voltage to the actuator 12 for a predetermined acceleration time. As the actuator 12 is controlled through a PWM [symbol] this equates to a maximum voltage applied continuously across a specific period of time. Preferably, the voltage applied across the acceleration time is at least 90% of the maximum allowable, and optionally the voltage applied is substantially 100% of the maximum allowable. In other words, there is a maximum energy that is possible to be expended on the actuator 12 across the acceleration time (as the energy is proportional to the accumulated power across the time period and thus, proportional to the voltage applied and for how long) [symbol] the controller 10 is operable to apply at least 90% of that maximum energy (i.e. the maximum PWM for at least 90% of the time available) and may approach or be at substantially 100% of the maximum energy (i.e. maximum PWM available for substantially the entirety of the acceleration time).

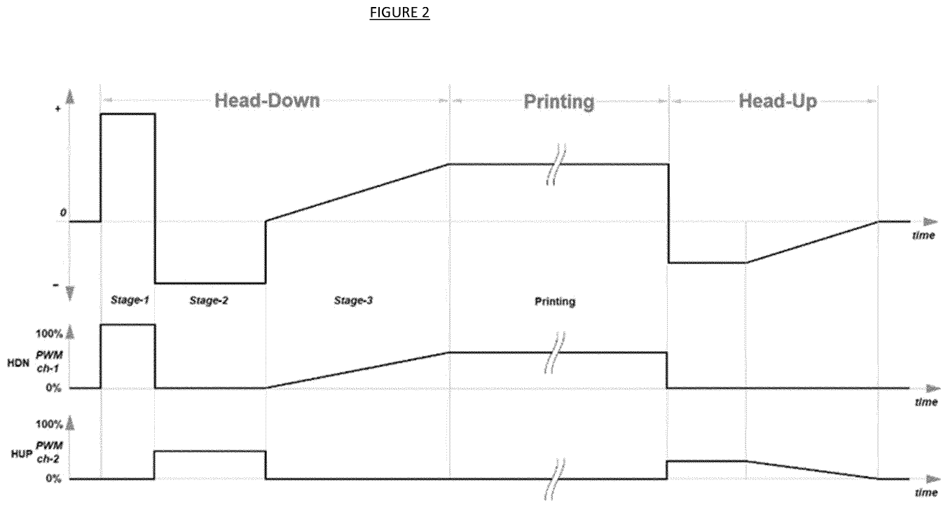

FIG. 2 illustrates the acceleration stage (labelled as [symbol] stage 1 [symbol] ). The top line shows an indication of the direction and magnitude of the voltage/power applied to the actuator 12 over time (on the x-axis). The middle PWM line shows the voltage applied only in the first direction (the [symbol] head down [symbol] direction) and the bottom PWM line show the voltage applied in the second direction (the [symbol] head up [symbol] direction) (both the bottom lines are represented as an absolute value).

As can be seen, in stage one/the initial acceleration step, the high print head actuator voltage/power is high. In other words, the maximum (or close to maximum) power/voltage is applied to the print head actuator 12 for stage one, so that the print head 14 is accelerated at a maximum possible rate. The head down channel ( [symbol] HDN [symbol] ) is at 100% to power the actuator 12 at a maximum possible.

In embodiments, the acceleration signal is maintained for a predetermined period of time. In other words, a high total energy signal is applied for a set period of time. In some examples, the controller 10 maintains the high actuator voltage (i.e. the maximum energy signal) for a set amount of time (which also ties into distance moved by the print head 14 towards the printing position). This time may depend on the distance between the nonprinting position and the printing position and/or how fast the print head 14 may be accelerated (i.e. the rate of acceleration).

The operation of slowing the print head 14 will now be discussed in more detail. The controller 10 slows the print head 14 before it reaches the printing position (i.e. the print head 14 is not contacting any surface), so that the print head 14 reaches the printing position while being slowed (i.e. the acceleration step is not active when the print head 14 reaches the printing position). In the present example, the controller 10 has a predetermined time period to slow the print head 14 [symbol] the braking time. This prevents the head 14 bouncing when it reaches print surface 16.

There are two general possibilities for slowing the print head 14. The first signal applied in the first direction in the acceleration stage may be removed (thus, allowing the current that is built-up to freewheel and decrease [symbol] the energy built into the actuator 12 over the acceleration stage dissipates).

Additionally to removing the [symbol] forward [symbol] signal (i.e. the acceleration signal), a braking signal could be used. In other words, a braking signal includes a second signal that is applied to the actuator in a second direction. The braking signal may include multiple pulse applied across the length of the braking signal.

In some embodiments, the braking signal may include a second voltage may be applied to the actuator 12 in a second polarity (in other words, controller 10 applies a negative/reversed print head actuator voltage [symbol] e.g. the signal is applied in the second direction). In this example, the second polarity is in the opposite direction to the first polarity. Essentially, the second voltage works against the current built up in the circuit during the acceleration stage (i.e. when the first voltage was applied) and forces the current down more quickly than allowing the current to freewheel. Thus, the print head 14 is braked and its speed is decelerated.

Thus, it should be appreciated that the controller 10 applies the braking signal to the actuator 12 for the predetermined braking time.

In other words, the signal (which may be a voltage signal) applied to the actuator 12 is zero or reversed in a controlled manner ensuring that the print head 14 reaches its print surface 16 without hitting it hard. The time and PWM of this negative/reversed voltage depends on mechanic mass, printer orientation and the gap (discussed in more detail later).

The option to provide a non-zero voltage in the second direction is illustrated in stage two in FIG. 2. As can be seen on the top PWM, a negative voltage is applied (the bottom two lines follow [symbol] i.e. there is 0V in the [symbol] head down [symbol] channel and a voltage applied in the [symbol] head up [symbol] channel).

It should be appreciated that for solenoids without the ability to change direction, the voltage could be turned off for a period to allow the solenoid [symbol] s speed to drop (i.e. the first possibility discussed above for slowing the print head 14). This can also be tuned to ensure the print head 14 reaches the print surface 16 without crashing into it. However, it should be appreciated that this process (from non-printing position to printing position) will slower as applying a negative voltage, since the print head 14 cannot be slowed down as quickly.

In some embodiments, the controller 10 applies the second signal in pulses across the predetermined braking time (i.e. the negative/reversed print head actuator voltage/PWM is pulsed to brake the print head 14). This allows the controller 10 to control the total energy applied across the whole of the braking time. In other words, by controlling the pulse length the controller 10 can impact the power applied across the braking time (i.e. the total energy developed). A shorter pulse length and/or fewer pulses with the maximum PWM in the second direction will mean a lower total energy over the braking time than a longer pulse length and/or more pulses. Thus, the braking of the print head 14 can be controlled to minimise unwanted print head 14 movement (e.g. bouncing, etc.).

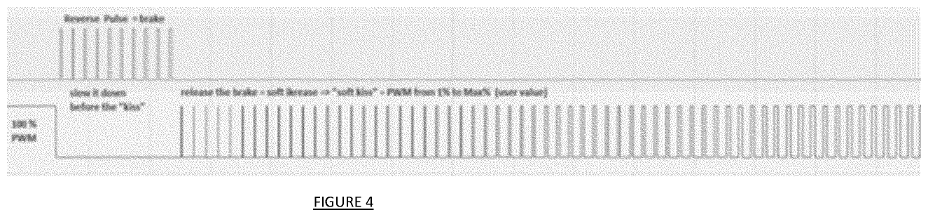

The third [symbol] stage [symbol] where the print head 14 contacts a surface 16 will now be discussed. Once the print head 14 contacts a surface (i.e. the printing surface 16) the printhead 14 is its printing position. In this position, the controller 10 increases a pressure of the print head 14 on the surface 16 to a printing pressure. The pressure is increased by applying a signal (which may be a voltage signal) in the first polarity/direction across the actuator 12. This is illustrated in [symbol] stage 3 [symbol] in FIG. 2 [symbol] in essence, the power applied to the actuator 12 (the solenoid or motor) is increased at a predetermined rate until a predetermined pressure is reached. In other words, the print head 14 is in contact with the printing surface 16 and the pressure between them is increased until an acceptable pressure for printing is reached. This is illustrated in FIG. 4 [symbol] the pulses illustrated on the bottom trace show how the pulse length can be gradually increased to increase the rate of power applied. In other words, the controller 10 operates to ensure the pressure is increased linearly (which may be proportional to a linear increase in the power (Watt/s) applied across the actuator 12.

In embodiments, the voltage (i.e. the PWM) is increased from 0 to a set point for given time. The power (or energy per time increment) is increased linearly from 0 to set point and has triangle shape (as illustrated in stage 3 of FIG. 2). The current increases in an S-shape. This minimises the print head 14 vibrations for given time and gap.

Once an acceptable pressure is reached (i.e. so that the printing apparatus is ready to begin printing), it is maintained [symbol] this is illustrated in the [symbol] printing [symbol] stage on FIG. 2. In embodiments, the acceptable pressure is between around 20 and 40 N.

The controller 10 algorithm can be tuned to ensure the print head 14 reaches the print surface 16 and the pressure is increased to the desired/printing pressure (i.e. the printing apparatus is ready to print) in the shortest amount of time possible. Stages one to three may take around 10 to 20 ms. In other words, it may take between 10 and 20 ms to move the print head 14 from the non-printing (e.g. at a resting or idle position/where the print head 14 returns to when not in use or powered down) to the printing position and printing pressure (i.e. ready to begin printing). It should be appreciated that the time depends on many things (e.g. one or more of the parameters listed below).

The entire process [symbol] e.g. acceleration, braking, gradual pressure increase, and printing pressure maintenance [symbol] is illustrated in FIG. 4. In short, FIG. 4 provides detail of the signals being applied in different parts of the [symbol] cycle [symbol] . The top trace illustrates the voltage/signal in the second direction (which translates to [symbol] head up [symbol] direction) and the bottom trace illustrates the voltage/signal in the first direction (which translates to [symbol] head down [symbol] direction) being applied over time. As can be seen, the maximum allowable is applied in the head down direction (i.e. the first direction) at the left side of the bottom trace (this is stage one/the acceleration step). Further, the reverse voltage/head-up signal (i.e. in the second direction) is pulsed over a predetermined period of time after the acceleration (this stage two/the slowing step). Lastly, the voltage in the first direction is built up over time to increase the print head 14 pressure on the printing surface 16 until the desired pressure is achieved and the pressure is maintained as necessary to proceed with printing.

In embodiments, the algorithm can be tuned differently for each orientation of the printer. The weight of the mechanics between the actuator 12 (the solenoid or DC-motor) and the print head 14 will change when the orientation changes. In some orientations, the mechanics are slightly heavier to the solenoid/actuator 12 than in other orientations. The algorithm compensates for this if the fastest possible pack rate is required. However, an algorithm can be tuned for all orientations.

The controller algorithm takes into account parameters relating to the printing apparatus to ensure that the above described process of operation provides a print head 14 in the printing position with minimal uncontrolled contact/impact on the printing surface 16 (in other words, the algorithm ensures a soft touch on the printing surface 16). Suitable parameters for the algorithm may include one or more of: [symbol] a print head gap (e.g. the distance between the non-printing position and the printing position) and / or force/pressure needed on the printing surface (i.e., 2, 3 or 4 Bars), [symbol] the platen softness, [symbol] the mass of the print head 14 and its width (for example, standard width for the print head 14 may be 53 or 128 mm across),

In some embodiments, the controller 10 is operable to reverse the acceleration process to move the print head 14 from its printing position to its non-printing position. The controller 10 may accelerate the print head 14 towards the non-printing position, followed by reducing the speed of the print head at a predetermined rate. In other words, the controller applies a retraction signal to the actuator to accelerate the print head towards the non-printing position. The retraction signal is at or approaching a maximum energy available (in the same way as discussed above).

The retraction signal may include a signal to the actuator in the second direction/polarity to accelerate the print head towards the non-printing position. In other words, in order to reverse the direction of the print head 14 (i.e. away from the printing surface 16), a negative/reversed print head actuator signal is applied (this reverse signal could be a voltage applied in the second direction). In some embodiments, the retraction signal is applied for a predetermined retraction time.

A braking action may not be necessary since the print head 14 does not hit a printing surface in the non-printing position. However, the controller 10 may reduce or reverse the retraction signal (which may be a negative print head actuator voltage) at a predetermined rate after the initial acceleration towards the non-printing position. It should be appreciated that the signals will be applied in the opposite direction to reach the nonprinting position from the printing position.

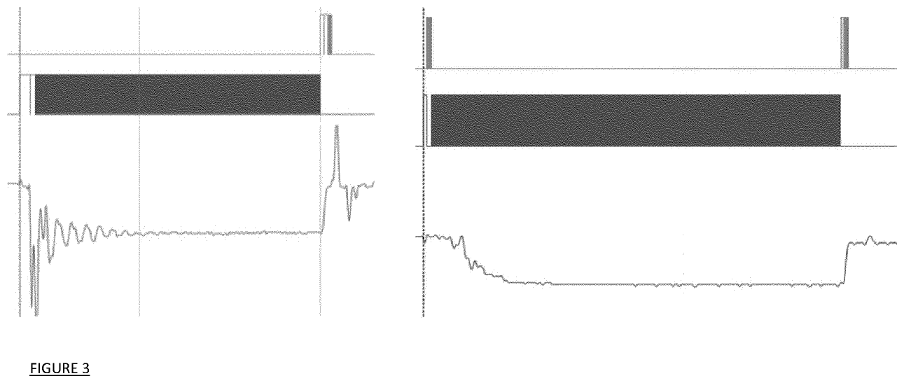

FIG. 3 illustrates two different systems [symbol] one in which none of the above techniques are implemented (left) and one according to embodiments of the invention (right). In both cases, the top trace illustrates the voltage applied in the second direction (i.e. reversed to initiate braking or head up movement), the middle trace illustrates the voltage applied in the first direction (i.e. acceleration or head down movement), and the bottom trace is an example load cell output giving an estimation of the pressure/position of the print head 14 on the surface 16. It should be appreciated that none of the axes have magnitudes included, so the shapes of the traces are the interesting part rather than any magnitudes.

As can be seen, on the left side (where no parts of the operation discussed above are included) the acceleration stage to move the print head 14 down is included at the start of the time period [symbol] the load cell illustrates the oscillating force output by the print head 14 bouncing on the printing surface 16. Further, there is a large spike in forces as the controller 10 moves the print head 14 to its non-printing position (shown on the right side of the traces) [symbol] this is again due to the fact that the controller 10 does not account or factor in the print head 14 hitting the upper extreme of its movement.

As can be seen, on the right side (where the braking signal/voltage in the second direction is included [symbol] see the signal on the top trace), the load cell illustrates much lower/reduced oscillation because the print head 14 is more stable when it contacts the printing surface 16 (i.e. there is reduced bouncing). Further, the same effect is notable on the opposing side of the figure where the print head 14 is moved away from the printing surface 16 to its non-printing position.

It should be appreciated that minimising/reducing print head bounce is advantageous as it reduces the wear on the components of the system. The print head 14 will be moved from its non-printing position to the printing position (and ready to print) thousands of times over the lifetime of the printing apparatus, so the reduction in wear is beneficial and extends the lifetime of the components (or at least reduces maintenance time and user input required).

Thus, the controller 10 is operable to perform a calibration process including completing at least first and second cycles (a [symbol] fake [symbol] print cycle) and comparing the results. Although it should be appreciated that it is likely that the controller 10 will complete many of these cycles to achieve an optimised process for the print head 14 movement.

The first cycle includes moving the print head 14 from the non-printing position to the printing position. In other words, the controller 10 simulates the process of moving the print head 14 to the printing position without starting any printing (i.e. to experience and calibrate the movement of the print head 14 without risking poor or reduced quality printing operations). This simulation may have parameters set that dictates the acceleration and the slowing steps (for example, total energy applied to the actuator 12 to generate the acceleration, a total energy applied to the actuator 12 to generate slowing or deceleration of the print head 14, and a time period over which one or both of above are applied, etc). In other words, the controller 10 implements the print head 14 control that is discussed above [symbol] at least the acceleration and the slowing is implemented but it should be appreciated one or more of the other features discussed above may be included too.

The controller 10 receives a signal/data relating to a back-electromotive force formed in/by the actuator 12. In other words, the controller 10 monitors the characteristics of the actuator throughout the first cycle.

The second cycle includes the controller 10 altering one or more parameter(s) relating to the movement of the print head 14 in the first cycle (i.e. an alteration in the acceleration and slowing steps is made). Suitable alterations may be assessed by the controller 10 by using the list of characteristics of the printing apparatus that influences the slowing process [symbol] for example, a mass and/or width of the print head, type and configuration of the actuator, supply voltage or power to the actuator, temperature of the actuator or environment, printing apparatus orientation, the distance between the non-printing position and the printing position. The print head 14 is again cycled from the non-printing position to the printing position with the updated parameter(s).

The controller 10 receives a signal/data relating to the back-electromotive force formed in/by the actuator 12 in the second cycle. In other words, similarly to the first cycle controller 10 monitors the characteristics of the actuator throughout the first cycle.

Lastly, the controller 10 compares the back-electromotive force between the first and second cycles to assess which parameter(s) result in acceptable movement of the print head 14.

In other words, the controller 10 can alter the parameters of the algorithm when the printing apparatus is started/power-up. At the printer boot-up time a Back-EMF gap calculation can be used and then applying proper algorithm parameters automatically. The Back-EMF gap is found by running one or more [symbol] fake [symbol] prints. Once those fake printing operations are complete, the controller may assess/alter one or more of the portions of the algorithm based on updated knowledge of one or more of the parameters outlined above. The controller 10 may alter one or more of: the magnitude of the voltages applied to the actuator 12 at a given point; the time the voltage is applied for; a pulse length or number of pulses required; pressure required between the print head 14 and the printing surface 16.

In some embodiments, moving the print head 14 from the non-printing position to the printing position includes accelerating the print head 14 towards the printing position by applied an actuation signal to the actuator 12 in the first direction. Further, it may include slowing the print head 14 before it reaches the printing position, so that the print head 14 reaches the printing position while being slowed. Slowing the print head 14 may include either removing the actuation signal of the first direction that is being applied to the actuator 12. Additionally, it may include applying a signal in the opposite direction to the actuator 12.

In embodiments, at power-on time, the printer may do around multiple [symbol] fake [symbol] prints (e.g. 10 or 20) with different pre-set parameters, and sample the solenoid current and the BackEMF. The Back-EMF shape is proven to have direct relation the vibrations.

It is found that if the Back-EMF is analysed with a Fast Fourier Transform (FFT), the representation with the smallest area under the FFT harmonic has least vibrations of the print head 14 (in this example, the controller 10 uses the first harmonic for this analysis). Thus, processing the Back-EMF in this way across multiple cycles allows the controller 10 to build up an assessment of which parameters should be used/what the quantities should be to minimise the print head 14 vibrations.

Essentially, the controller 10 knows what the current through the actuator is across time when no Back-EMF is present [symbol] this forms a base line or reference current. The controller 10 then monitors the current through the actuator 12 during each cycle that it performs. The actuator 12 will generate a Back-EMF as a natural consequence of the power being applied to it and as it changes, etc, which affects the current being output to the controller 10. Thus, the controller 10 can compare the actual/real life current output to the reference current, which allows the assessment of the Back-EMF present.

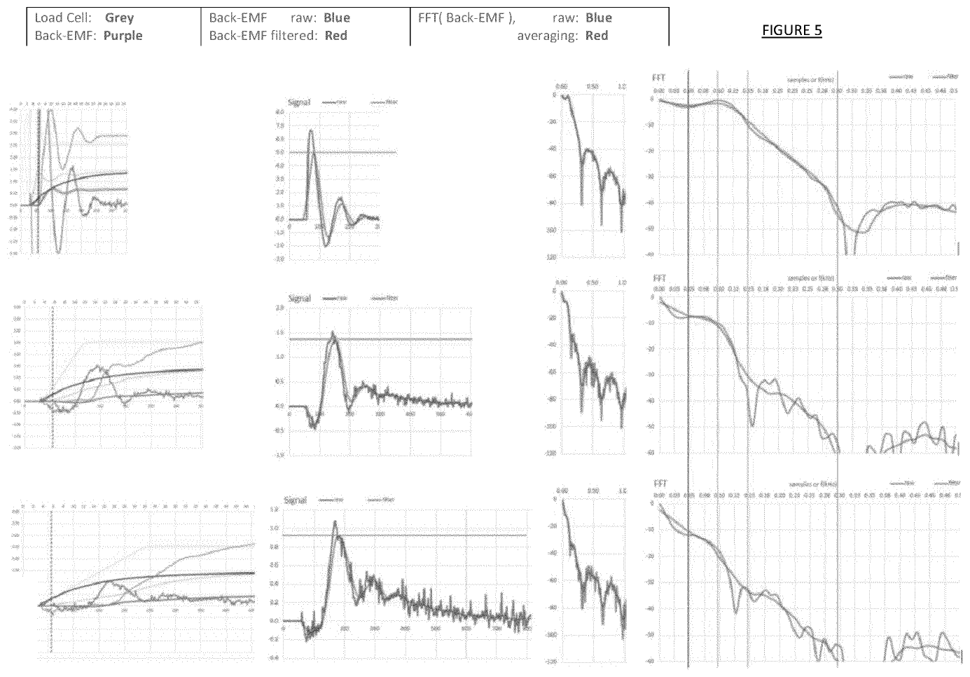

FIG. 5 provides experimental results from implementing this general process. Of interest in the left hand graphs, a load cell output is included in grey and a Back-EMF reading is in purple. In the middle graphs, the unfiltered/raw Back-EMF is included in blue and a filtered representation of the Back-EMF is in red. In the right graphs, a FFT analysis is shown [symbol] the raw output of the FFT is in blue and the filtered version is in red. Thus, the graphs give an indication of test measurements illustrating the analysis on the Back-EMF after Low-Pass-Filtering. The graphs at the top of the block of nine as those that exhibit most vibrations [symbol] i.e. the area under the filtered FFT is highest. Those in the middle give medium level vibrations and those at the bottom exhibit fewest vibrations [symbol] i.e. the area under the filtered FFT is lowest.

For experimental purposes, we can see that the grey trace on the left hand graph of the bottom row agrees with the assessment that this set-up has lowest vibrations.

With reference to the discussion above, essentially, each of the graphs illustrated in FIG. 5 provides feedback from different sensors relating to the print head movement, location and action. The grey and purple traces are a load cell and back-EMF respectively and in general provide an indication of the vibration of the print head 14. Each row of graphs is under a different set of operating signal characteristics for the actuator 12 (i.e. to move the printhead). In other words, each row represents a different [symbol] fake print [symbol] or the first and second cycles in the calibration method. Each cycle (i.e. row of graphs) has one or more parameter(s) relating to the movement of the print head 14 altered to monitor the result.

The controller 10 may perform many of these cycles with small iterative differences in the acceleration signal and braking signal before true printing operations start. Thus, the controller 10 assesses what set of parameters for these signals will be most appropriate (i.e. finding a balance between minimising print head 10 bounce and protecting the components from excessive wear and ensuring the print head 14 arrives the printing position quickly, so time is not wasted). As above, the controller 10 can assess the feedback from these cycles (possibly using a filtered FFT process) to make an assessment of the print head 14 vibrations experienced with the set of parameters used to move the print head 14 to its printing position.

A calibration phase (i.e. completing all the necessary cycles to establish what parameters to set for the print head 14 in an upcoming printing operation or printing phase) may involve more than 50 cycles ( [symbol] fake prints [symbol] ) and may be around 100 cycles. Once cycle may take around 10 to 40 ms, so the calibration time may be 1 to 4 seconds depending on the average time for each cycle. It should be appreciated that it may be that a more hostile print environment (e.g. difficult printing conditions, difficult materials being used for printing, etc.) may involve a longer calibration time/more cycles to obtain the ideal set of parameters. Likewise, an environment that is similar to an earlier print environment or is straight forward from a printing perspective may require a shorter calibration time/fewer cycles in order to reach a position in which printing can begin.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

Protection may be sought for any features disclosed in any one or more published documents referenced herein in combination with the present disclosure.

Although certain example embodiments of the invention have been described, the scope of the appended claims is not intended to be limited solely to these embodiments. The claims are to be construed literally, purposively, and/or to encompass equivalents.

1. A printing apparatus for thermal transfer printing, including a controller, an actuator, and a print head which is moveable by the actuator, between a non-printing position and a printing position, the controller is operable to control movement of the print head from the non-printing position to the printing position by:
accelerating the print head towards the printing position,
slowing the print head before it reaches the printing position, so that the print head reaches the printing position while being slowed,
contacting a surface with the print head in the printing position and increasing a pressure of the print head on the surface to a printing pressure.

2. A printing apparatus according to claim 1 wherein the controller applies an acceleration signal to the actuator to accelerate the print head, and the acceleration signal is at or approaching a maximum energy available, and preferably at least 90% of the maximum allowable.

3. A printing apparatus according to claim 2 wherein the acceleration signal includes a first signal to the actuator in a first direction.

4. A printing apparatus according to claim 2 or 3 wherein the controller applies the acceleration signal for a predetermined acceleration time.

5. A printing apparatus according to any one of the preceding claims wherein slowing the print head includes actively decelerating the print head.

6. A printing apparatus according to any one of the preceding claims wherein the controller applies a braking signal to the actuator to slow the print head, and optionally the braking signal includes a second signal to the actuator in a second direction.

7. A printing apparatus according to claim 6 wherein the controller applies the braking signal for a predetermined braking time.

8. A printing apparatus according to claim 6 or 7 wherein the controller applies the braking signal in pulses across the predetermined braking time.

9. A printing apparatus according to claim 7 or 8 wherein the controller adjusts a magnitude of the energy applied during the braking signal according to at least one of:
a mass of the print head,
a width of the print head,
a type and configuration of the actuator,
a supply voltage or power to the actuator,
a temperature of the actuator or environment,
a printing apparatus orientation,
a distance between the non-printing position and the printing position.

10. A printing apparatus according to any one of the preceding claims wherein as/after the print head contacts the surface the controller applies an increasing signal to the actuator at a predetermined rate to reach the printing pressure.

11. A printing apparatus according to claim 10 wherein the predetermined rate increase is linear.

12. A printing apparatus according to any one of the preceding claims wherein the controller is operable to control movement of the print head from the printing position to the non-printing position by:
accelerating the print head towards the non-printing position, and
slowing the print head before it reaches the non-printing position.

13. A printing apparatus according to claim 12 wherein the controller applies a retraction signal to the actuator to accelerate the print head towards the non-printing position, and the retraction signal is at or approaching a maximum energy available.

14. A printing apparatus according to claim 13 wherein the retraction signal includes a signal in the second direction to accelerate the print head towards the non-printing position.

15. A printing apparatus according to claim 13 or 14 wherein the controller applies the retraction signal to the actuator for a predetermined retraction time.

16. A printing apparatus according to any one of claims 12 to 15 wherein the controller applies a retraction braking signal to slow the print head before it reaches the nonprinting position, and optionally the retraction braking signal includes a signal in the first direction.

17. A printing apparatus according to claim 16 wherein the controller applies retraction braking signal for a predetermined time.

18. A method of operating a printing apparatus according to any one of the preceding claims.

19. A printing apparatus for thermal transfer printing, including a controller, an actuator, and a print head which is moveable by the actuator, between a non-printing position and a printing position, the controller is operable to perform a calibration process including:
completing a first cycle including moving the print head from the non-printing position to the printing position, and receiving a signal/data relating to a backelectromotive force formed in/by the actuator,
completing a second cycle including altering one or more parameter(s) relating to the movement of the print head in the first cycle, moving the print head from the non-printing position to the printing position with the updated parameter(s), receiving a signal/data relating to the back-electromotive force formed in/by the actuator, and
comparing the back-electromotive force between the first and second cycles to assess which parameter(s) result in acceptable movement of the print head.

20. A printing apparatus according to claim 16 wherein moving the print head between the non-printing position and the printing position includes the controller:
accelerating the print head towards the printing position by applying an actuation signal to the actuator in a first direction,
slowing the print head before it reaches the printing position, so that the print head reaches the printing position while being slowed.

21. A printing apparatus according to claim 17 wherein slowing the print head includes either removing the actuation signal of the first direction being applied to the actuator and/or applying a signal in the opposite direction/a second direction to the actuator.

22. A printing apparatus according to any one of claims 16 to 18 wherein the one or more parameters includes one or more of:
a total energy applied to the actuator to generate the acceleration,
a total energy applied to the actuator to generate slowing or deceleration of the print head, and
a time period over which one or both of above are applied.

23. A printing apparatus according to claim 20 wherein the total energy applied to the actuator to generate slowing or deceleration is influenced by one or more of the following:
a mass of the print head,
a width of the print head,
a type and configuration of the actuator,
a supply voltage or power to the actuator,
a temperature of the actuator or environment,
a printing apparatus orientation,
a distance between the non-printing position and the printing position.
